(19) United States
(12) Patent Application Publication
(10) Pub. No.: US 2014/0266725 A1
(43) Pub. Date: Sep. 18, 2014

(54) KIOSK SECURITY FOR PORTABLE ELECTRONIC DEVICE

(71) Applicant: InVue Security Products Inc., Charlotte, NC (US)

(72) Inventors: David N. Berglund, Charlotte, NC (US); Gary A. Taylor, Fort Mill, SC (US); Jeffrey A. Grant, Charlotte, NC (US)

(73) Assignee: InVue Security Products Inc., Charlotte, NC (US)

(21) Appl. No.: 14/199,176

(22) Filed: Mar. 6, 2014

Related U.S. Application Data
(60) Provisional application No. 61/791,593, filed on Mar. 15, 2013.

(51) Int. Cl. G08B 13/14

(52) U.S. Cl. CPC G08B 13/14
USPC 340/568.8

(57) ABSTRACT

An anti-theft device for protecting a portable electronic device from theft or unauthorized removal in a retail environment is provided. The anti-theft device includes a dock configured to temporarily receive and support the portable electronic device and an alarming device configured to arm when the portable electronic device is positioned within the dock. The alarming device is configured to be disarmed by an authorized user for removing the portable electronic device from the dock.

### CROSS REFERENCE TO RELATED APPLICATIONS

The present application claims priority to U.S. Provisional Application No. 61,791,593, filed Mar. 15, 2013, the contents of which are incorporated by reference herein in its entirety.

### BACKGROUND OF THE INVENTION

Embodiments of the present invention relate generally to anti-theft devices for protecting consumer or point-of-sale electronic devices.

A recent trend in retail environments is to use smart devices, sometimes cellphones, but more often tablets, as customer service devices. This usage takes on two forms. One form is using a tablet as a kiosk where customers can interact with the device. This may be used to deliver information about the establishment or its products to the consumer or even act as an interface for customer loyalty programs in lieu of plastic cards. A second usage is for store personnel to take these devices with them around the store to help assist customers. The associate might do things like pull up a store map to show a customer where an item is, check on a price of an item, or pull up specifications on a product a customer is considering buying. In some stores, the tablets are even being used to check out customers on the spot. Restaurants might use these devices at a table for ordering or game playing. Entities such as hospitals may allow doctors and nurses to carry around these smart devices for instant access to patient's health charts.

This trend requires both customer and store associates to interact with smart devices that tend to be fairly expensive. In some instances, the store associate or employee may need to leave the smart device unattended to attend to another task. Thus, there is a need for an anti-theft device for protecting portable electronic devices from theft while still allowing sufficient user interaction.

### BRIEF SUMMARY

Embodiments of the present invention are directed to anti-theft devices for protecting a portable electronic device from theft or unauthorized removal. According to one embodiment, the anti-theft device includes a dock configured to temporarily receive and support a portable electronic device (e.g., a tablet device) and an alarming device configured to arm when the portable electronic device is positioned within the dock. The alarming device is configured to be disarmed by an authorized user for removing the portable electronic device from the dock.

### BRIEF DESCRIPTION OF THE DRAWINGS

FIG. 1 is a front perspective view of an anti-theft device according to one embodiment of the present invention.

FIG. 2 is a side view of the anti-theft device shown in FIG. 1.

FIG. 3 is a rear perspective view of the anti-theft device shown in FIG. 1.

FIG. 4 is a perspective view of a dock according to one embodiment of the present invention.

FIG. 5 is a side view of the dock shown in FIG. 4.

FIG. 6 is another perspective view of a dock according to one embodiment of the present invention.

FIG. 7 is a rear perspective view of the dock shown in FIG. 6.

### DETAILED DESCRIPTION OF EMBODIMENTS OF THE INVENTION

Embodiments of the present invention will now be described more fully hereinafter with reference to the accompanying drawings, in which various embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

Reference will now be made to the accompanying drawing figures wherein identical reference numerals denote the same or similar elements throughout the various views. The attached figures show an exemplary embodiment of an anti-theft device, indicated generally by reference character 20 in various figures, for protecting a tablet or similar portable electronic device, indicated generally by reference character “T” in various figures, against theft or unauthorized removal. As used herein, the term “tablet” is intended to include without limitation all types of portable, personal computers, for example laptop, notebook, mini-notebook, sub-notebook and netbook type computers, as well as personal data assistant (PDA) type devices.

Embodiments of the present invention are directed to anti-theft devices 20 comprising a dock 30 or docking station configured to temporarily secure the portable electronic device T to the dock, which may be attached to a counter or wall, in a retail environment (e.g. a retail store), such as with one or more fasteners and/or adhesive. In some instances, the portable electronic device T is configured to be readily placed within the dock 30 and removed from the dock by an authorized user while servicing customers. For example, a retail associate may utilize a tablet for point-of-sale transactions and wish to temporarily secure the tablet. In addition, the dock 30 may also be configured to be alarmed, locked, and/or otherwise secured so that unauthorized personal cannot remove it. In one embodiment, the anti-theft device 20 includes an alarming device 32 configured to arm when the portable electronic device T is positioned within the dock and to disarm when the portable electronic device is removed by an authorized user. The portable electronic device T may be operably engaged with the dock 30 and/or the alarming device 32 in a wireless manner, although wired means may be used if desired. FIG. 4 shows one embodiment of a dock 30 configured to support and secure the portable electronic device T, although other shapes and configurations are possible for supporting a variety of portable electronic devices. In some embodiments, the portable electronic device T is at least partially enclosed within a shroud “S” as shown in FIGS. 1-3. The shroud S and portable electronic device T may be configured to be supported by the dock 30 as shown.

The dock 30 may include a mechanical mechanism 55, such as a plunger switch, operably engaged with the alarming device 32 and configured to activate in response to engagement and disengagement with the portable electronic device. (see, e.g., FIG. 5). FIG. 7 shows that a pair of plunger switches may be used, although one or more switches may be used as desired. The authorized user may utilize a key, passcode, or the like to disarm the alarming device. In some embodiments, the dock 30 is configured to power up and/or charge the device. In this case, the anti-theft device 20 may include a power input cord coupled to the dock 30.

FIGS. 1-5 illustrate an embodiment of a dock 30 for temporarily receiving and supporting a portable electronic device T. The dock 30 includes an opening 35 configured to receive a portion of the portable electronic device T for supporting the device in a desired position and orientation. The dock 30 may also include a lip 45 that is configured to overlie an edge of the portable electronic device T. The lip 45 projects towards the screen of the portable electronic device T such that in order for the device to be removed from the dock 30, the device must be pivoted away from the lip. Thus, the lip 45 secures the portable electronic device T to the dock 30, which may prevent unintended undocking of the device. In some instances, a pre-alarm may be activated for a predetermined period of time (e.g. about 5 seconds) when the portable electronic device T is removed from the dock 30, which allows the device to be repositioned within the dock without prompting an alarming signal. An LED or other signaling device 46 may be used to indicate that the anti-theft device is armed. In addition, the alarming device 32 may be configured to generate an alarming signal (e.g., an audible and/or a visible alarm) in response to unauthorized removal of the portable electronic device T from the dock 30. In one embodiment shown in FIGS. 6 and 7, the dock 30 may include one more recesses 60 for receiving a portion of the shroud S therein. For instance, FIG. 3 shows that the recesses 60 may be configured to accommodate a protrusion on the outer surface of the shroud S for ensuring that the shroud and portable electronic device T are securely received and positioned within the dock 30.

In some embodiments, the anti-theft device 20 comprises a lock mechanism 36 for securing the portable electronic device the dock (see, e.g., FIG. 2). For example, the lock mechanism 36 may be configured to automatically lock when the portable electronic device T is positioned within the dock 30. In order to release the portable electronic device T, an authorized user could a key or some other security means (e.g. a passcode) to disarm the alarming device 32 and/or disengage the lock mechanism 36. In some instances, a customized adapter or shroud S may be operably engaged with the portable electronic device T and configured to engage with the lock mechanism 36. This may be carried out using a shroud S that covers the portable electronic device T except for the screen, but could be accomplished in other ways, for example, attaching the locking features with adhesive to the back of the portable electronic device.

Another embodiment of a lock mechanism 36 comprises an electro-mechanical connection between the dock 30 and the portable electronic device T. For instance, an electro-mechanical lock may be configured to move into place when triggered by the portable electronic device T being docked, such as with one or more pressure switches or similar means of detecting the presence of the portable electronic device. Where the portable electronic device T includes a shroud S, a mechanical lock may then engage the locking features on the shroud. Another embodiment of a lock mechanism 36 is an electromagnetic lock. Again, the portable electronic device T would be detected upon docking in the dock 30, but in this embodiment, an electromagnet would engage, holding the portable electronic device to the dock with magnetics.

An unlocking feature for removing the portable electronic device T or disarming the alarming device 32 may take many forms. One embodiment is an electrical key utilizing radio frequencies, infrared, or some other electronic means to communicate with the dock 30 and/or alarming device 32 to allow the portable electronic device T to be released. For example, the dock 30 may include a port 50 for receiving a signal from the key. Other simpler embodiments might include standard mechanical keys or magnetic keys that move locking members inside the dock 30.

In another embodiment, the anti-theft device 20 may include a sensor 40. For example, the sensor 40 may be an inductive sensor for sensing the presence of the portable electronic device T. For example, the sensor 40 may be configured to directly detect the presence of the portable electronic device T. In one embodiment, the sensor 40 may include an inductive coil configured to sense the presence of metal or other property of the portable electronic device T. A first reading may be taken when the portable electronic device T is docked in the dock 30, and when a device is docked again at a later time, another reading can be made and compared to the first reading. If the difference in the readings is greater than a predetermined value, it may be determined that the portable electronic device T has been swapped with another device, thereby triggering an alarming signal.

In another embodiment, the means of securing the portable electronic device T is an electro-magnetic interface. A piece of conductive material or metal may be attached to the portable electronic device T, such as with adhesive, glue, or a shroud S that encases the entire device and has metal as a component. A dock 30 may be configured to receive the portable electronic device T with a metal plate attached. A means of detecting when the portable electronic device T is in the dock 30 triggers the electromagnet to be turned on, thus attracting the metal plate to the magnet and securing the portable electronic device to the dock. In addition, the dock 30 may have an alarming device 32 to detect unauthorized removal of the portable electronic device T from the dock. As before, a key may be used to authorize the dock 30 to turn off the magnet and allow the portable electronic device T to be removed. This key can take many forms from a traditional mechanical lock to a touchpad with a security code to some form of electronic key that can communicate a hidden security code to the base.

In other embodiments, the anti-theft device 20 may include circuitry for automatically recognizing the portable electronic device T. For example, the portable electronic device T may comprise a program for communicating with the alarming device circuitry via wireless means (e.g. Bluetooth communication). As such, the anti-theft device 20 may be configured to automatically detect the presence of a particular portable electronic device T. In this way, the portable electronic device T may include an application that provides the functionality for communicating with the circuitry of the anti-theft device 20.

In another embodiment, the portable electronic device T may include a program for detecting motion thereof and arming or disarming the device based on such motion. For instance, the portable electronic device T may include an accelerometer for detecting motion of the device. The accelerometer may be configured to sense when the portable electronic device T has been placed on a table or other surface and is automatically armed. When the portable electronic device T is picked back up, the device may be configured to ask for authorization (e.g. a passcode) within a predetermined period of time before an alarming signal is activated. In this case, the portable electronic device T may include a speaker for providing an audible alarming signal. The accelerometer may be sensitive enough to distinguish between holding the portable electronic device T substantially still versus placing the device on a table or other support surface.

The foregoing has described one or more embodiments of an anti-theft device for protecting a tablet or similar portable electronic device from theft or unauthorized removal. Those of ordinary skill in the art will understand and appreciate that numerous variations and modifications of the invention may be made without departing from the spirit and scope of the invention. Accordingly, all such variations and modifications are intended to be encompassed by the appended claims.

That which is claimed is:

1. An anti-theft device for protecting a portable electronic device from theft or unauthorized removal in a retail environment, comprising:
a dock configured to temporarily receive and support the portable electronic device; and
an alarming device configured to arm when the portable electronic device is positioned within the dock,
wherein the alarming device is configured to be disarmed by an authorized user for removing the portable electronic device from the dock.

2. The anti-theft device of claim 1, further comprising a lock mechanism for locking the portable electronic device within the dock.

3. The anti-theft device of claim 2, wherein the lock mechanism comprises an electromagnet.

4. The anti-theft device of claim 2, wherein the lock mechanism comprises a mechanical latch for engaging the portable electronic device.

5. The anti-theft device of claim 2, further comprising a shroud configured to house the portable electronic device, wherein the shroud is configured to engage with the lock mechanism.

6. The anti-theft device of claim 2, wherein the lock mechanism is configured to be disengaged by an authorized user for removing the portable electronic device from the dock.

7. The anti-theft device of claim 1, wherein the alarming device is operably engaged with the dock.

8. The anti-theft device of claim 7, wherein the dock comprises a plunger switch operably engaged with the alarming device and configured to activate in response to engagement and disengagement with the portable electronic device.

9. The anti-theft device of claim 1, wherein the dock comprises a port for receiving a signal therein from a key for disarming the alarming device.

10. The anti-theft device of claim 1, further comprising an inductive sensor for sensing the presence of the portable electronic device.

11. The anti-theft device of claim 1, further comprising circuitry for automatically recognizing the portable electronic device.

12. The anti-theft device of claim 10, wherein the portable electronic device comprises a program for communicating with the circuitry.

13. The anti-theft device of claim 1, wherein the portable electronic device comprises a tablet used by retail personnel.

14. The anti-theft device of claim 1, wherein the dock comprises an opening sized and configured to receive a portion of the portable electronic device.

15. The anti-theft device of claim 14, wherein the dock comprises a lip defined adjacent to the opening sized and configured to overlie an edge of the portable electronic device.

16. The anti-theft device of claim 1, wherein the portable electronic device is configured to be secured wirelessly within the dock.
